(19) United States
(12) Patent Application Publication
(10) Pub. No.: US 2020/0064875 A1
(43) Pub. Date: Feb. 27, 2020

(54) IN-RUSH CURRENT PROTECTION FOR LINEAR REGULATORS

(71) Applicant: Synaptics Incorporated, San Jose, CA (US)

(72) Inventors: Kishan Reddy Gonapati, Andhrapradesh (IN); Aswani Aditya Kumar Tadinada, Telangana (IN); Manoja Dangeti, Gachibowli (IN); Sivankumar Pandian, Hyderabad (IN)

(21) Appl. No.: 16/153,648

(22) Filed: Oct. 5, 2018

(30) Foreign Application Priority Data
Aug. 24, 2018 (IN) 201841031723

(51) Int. Cl. G05F 1/573; G05F 1/46

(52) U.S. Cl. CPC G05F 1/573; G05F 1/468

(57) ABSTRACT

A linear voltage regulator including a pass element, an error amplifier, and in-rush current protection (ICP) circuitry. The pass element is configured to produce an output voltage across a capacitor based on a received input voltage. The error amplifier is configured to output a control voltage based at least in part on the output voltage and a reference voltage. The control voltage is used to control a flow of output current through the pass element. The ICP circuitry is coupled to the pass element and the error amplifier and configured to maintain the output current below a threshold level while charging the capacitor from a discharged state to the output voltage.

### CROSS REFERENCE TO RELATED APPLICATIONS

This application claims priority under 35 U.S.C. 119(b) to co-pending and commonly owned Indian Patent Application No. 201841031723 entitled “IN-RUSH CURRENT PROTECTION FOR LINEAR REGULATORS” filed on Aug. 24, 2018, the entirety of which is incorporated by reference herein.

### TECHNICAL FIELD

The present embodiments relate generally to linear regulators, and specifically to in-rush current protection for linear regulators.

### BACKGROUND OF RELATED ART

A linear regulator may be configured to receive an input voltage and produce a relatively stable output voltage that is resistant to ripple or other small voltage variations in the input voltage. For example, the linear regulator may maintain the output voltage by varying its effective resistance (e.g., corresponding to the resistance of a pass element) in response to changes in an amount of current flowing through a load element coupled to its output. Accordingly, the output voltage of the linear regulator should be lower than the input voltage by at least a saturation or overdrive voltage to maintain the pass element in saturation. However, in some instances, the pass element may not remain in saturation, which may push the output voltage closer to the input voltage. The minimum voltage difference between the output voltage and the input voltage is referred to as “dropout voltage.” A low-dropout (LDO) regulator is a linear regulator with a very small dropout voltage (e.g., <2V). LDO regulators are often used for producing supply voltages within low-voltage microprocessors or other integrated circuit (IC) devices.

LDO regulators with very low dropout voltages, high load currents, and high external capacitances tend to draw large amounts of in-rush current during power-up or initialization. In some instances, a sufficiently large surge of in-rush current may collapse or burn the wiring of the power supply grid on which the LDO regulator operates, resulting in permanent damage to the device. Thus, it may be desirable to control the flow of in-rush current when powering on the LDO regulator.

### SUMMARY

This Summary is provided to introduce in a simplified form a selection of concepts that are further described below in the Detailed Description. This Summary is not intended to identify key features or essential features of the claims subject matter, nor is it intended to limit the scope of the claimed subject matter.

A linear voltage regulator including a pass element, an error amplifier, and in-rush current protection (ICP) circuitry is disclosed. The pass element is configured to produce an output voltage across a capacitor based on a received input voltage. The error amplifier is configured to output a control voltage based at least in part on the output voltage and a reference voltage. The control voltage is used to control a flow of output current through the pass element. The ICP circuitry is coupled to the pass element and the error amplifier and configured to maintain the output current below a threshold level while charging the capacitor from a discharged state to the output voltage. For example, the ICP circuitry may be configured to charge the capacitor when powering on the linear voltage regulator.

In some implementations, the ICP circuitry may include a pre-charge circuit configured to charge the capacitor to a first threshold voltage while preventing the pass element from providing the output current to the capacitor. For example, the pre-charge circuit may include switching circuitry configured to selectively suppress the reference voltage at an input of the error amplifier, and a transistor coupled in parallel with the pass element and configured to provide a pre-charge current to the capacitor when the reference voltage is suppressed. In some aspects, a low-pass filter may be coupled to the input of the error amplifier to filter the reference voltage. The gate of the transistor may be switchably coupled to the output of the error amplifier based at least in part on the charge on the capacitor. For example, the gate may be coupled to the output of the error amplifier when the capacitor is charged to the first threshold voltage. More specifically, the transistor may be configured to provide at least a portion of the output current when the gate is coupled to the output of the error amplifier.

In some other implementations, the ICP circuitry may include a voltage clamp configured to throttle the output current through the pass element when the charge on the capacitor is below a second threshold voltage. For example, the voltage clamp may include one or more transistors coupled between the output of the error amplifier and a first voltage potential. In some aspects, the one or more transistors may be configured to pull the control voltage toward the first voltage potential when the charge on the capacitor is below the second threshold voltage. For example, an impedance across the one or more transistors may be lower than an output impedance of the error amplifier. In some aspects, the first voltage potential may correspond to the input voltage. Moreover, at least one of the one or more transistors may be turned off when the charge on the capacitor reaches the second threshold voltage.

### BRIEF DESCRIPTION OF THE DRAWINGS

The present embodiments are illustrated by way of example and are not intended to be limited by the figures of the accompanying drawings.

FIG. 1 is a block diagram of an LDO regulator with in-rush current protection, in accordance with some embodiments.

FIG. 2 is a circuit diagram of an LDO regulator with pre-charge circuitry and a voltage clamp, in accordance with some embodiments.

FIG. 3A shows an example LDO pre-charge controller, in accordance with some embodiments.

FIG. 3B shows an example LDO pre-enable controller, in accordance with some embodiments.

FIG. 3C shows an example LDO voltage clamp controller, in accordance with some embodiments.

FIG. 4 is a circuit diagram of an LDO regulator with in-rush current protection circuitry, in accordance with some embodiments.

FIG. 5A shows another example LDO voltage clamp controller, in accordance with some embodiments.

FIG. 5B is another circuit diagram of an LDO regulator with in-rush current protection circuitry, in accordance with some embodiments.

FIG. 6 is an illustrative flowchart depicting an example operation for mitigating in-rush current in an LDO regulator, in accordance with some embodiments.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. The interconnection between circuit elements or software blocks may be shown as buses or as single signal lines. Each of the buses may alternatively be a single signal line, and each of the single signal lines may alternatively be buses, and a single line or bus may represent any one or more of a myriad of physical or logical mechanisms for communication between components.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory computer-readable storage medium comprising instructions that, when executed, performs one or more of the methods described above. The non-transitory computer-readable storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors. The term “processor,” as used herein may refer to any general purpose processor, conventional processor, controller, microcontroller, and/or state machine capable of executing scripts or instructions of one or more software programs stored in memory.

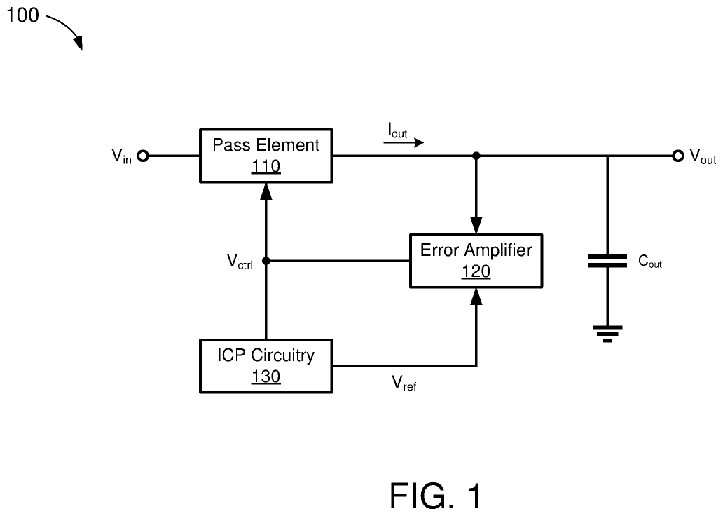

FIG. 1 is a block diagram of an LDO regulator 100 with in-rush current protection, in accordance with some embodiments. The LDO regulator 100 may produce an output voltage Vₒᵤₜ based, at least in part, on a received input voltage Vᵢₙ. The input voltage Vᵢₙ may be supplied by a direct-current (DC) voltage source (not shown for simplicity), which may produce ripple or other small voltage variations. However, the LDO regulator 100 may be configured to maintain the output voltage Vₒᵤₜ at a substantially stable voltage level even in the presence of voltage variations in the input voltage Vᵢₙ. More specifically, the LDO regulator 100 may provide a variable output current Iₒᵤₜ to an external load (such as a processor or other circuitry with a variable resistance and/or capacitance) while maintaining a relatively steady output voltage Vₒᵤₜ across the load.

The LDO regulator 100 may include a pass element 110, an error amplifier 120, and in-rush current protection (ICP) circuitry 130. The pass element 110 may have a variable resistance (or capacitance) that is adjustable via a control voltage V_{ctrl}. More specifically, the control voltage V_{ctrl} may control a voltage drop across the pass element 110. For example, in some implementations, the pass element 110 may comprise one or more metal-oxide semiconductor field-effect transistors (MOSFETs), such as PMOS transistors and/or NMOS transistors. In some other implementations, the pass element 110 may comprise one or more bipolar junction transistors (BJTs), such as NPN transistors and/or PNP transistors.

The error amplifier 120 compares the output voltage Vₒᵤₜ (or a fraction thereof) with a reference voltage V_{ref} and adjusts the control voltage V_{ctrl} based, at least in part, on a difference between the voltages. During operation, variations in the input voltage Vᵢₙ and/or changes in resistance of the external load may cause changes in the output current Iₒᵤₜ. Such changes in the output current Iₒᵤₜ may, in turn, affect the output voltage Vₒᵤₜ. The error amplifier 120 adjusts the voltage drop across the pass element 110 (e.g., by changing a resistance of the pass element 110), in response to changes in the output current Iₒᵤₜ, to maintain the output voltage Vₒᵤₜ at a relatively constant voltage. The error amplifier 120 may have a relatively high output impedance. For example, the error amplifier 120 may be implemented by a folded cascode error amplifier, a telescopic error amplifier, or any suitable two-stage error amplifier.

In the example of FIG. 1, a capacitor Cₒᵤₜ is coupled to the output of the LDO regulator 100 to filter and/or maintain the output voltage Vₒᵤₜ. For example, when charged, the capacitor Cₒᵤₜ may resist large instantaneous changes in the output current Iₒᵤₜ. However, the capacitor Cₒᵤₜ may be initially discharged (e.g., to 0V) prior to powering on the LDO regulator 100. Thus, during device power-up, the capacitor Cₒᵤₜ may act as a shunt, drawing a substantial amount of in-rush current from the input voltage Vᵢₙ. As described above, a sufficiently large surge of in-rush current may collapse the power supply grid on which the LDO regulator 100 operates.

In some embodiments, the ICP circuitry 130 may control the flow of in-rush current when powering on the LDO regulator 100. More specifically, the ICP circuitry 130 may throttle the output current Iₒᵤₜ, during device power-up, by adjusting the resistance of the pass element 110. In some aspects, the ICP circuitry 130 may pre-charge the capacitor Cₒᵤₜ to a predetermined level (e.g., by controlling the reference voltage V_{ref} provided to the error amplifier 120 and the control voltage V_{ctrl} provided to the pass element 110) to reduce the draw of output current Vₒᵤₜ by the capacitor Cₒᵤₜ. In some other aspects, the ICP circuitry 130 may maintain a resistance of the pass element 110 at a relatively high level (e.g., by clamping the control voltage V_{ctrl} to a predetermined voltage) to limit the flow of output current through the pass element 110. After the output current Iₒᵤₜ reaches a substantially steady-state level, the ICP circuitry 130 may be deactivated or bypassed, thus allowing the LDO regulator 100 to resume normal operation.

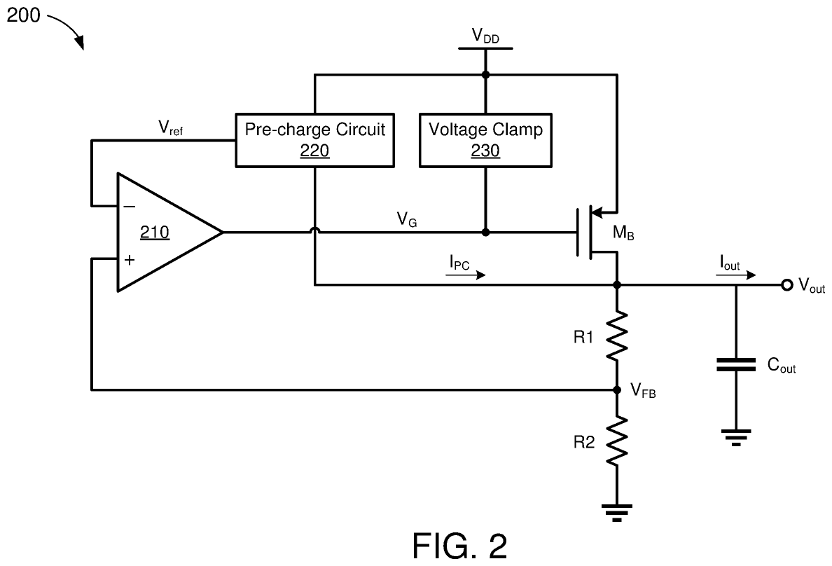

FIG. 2 is a circuit diagram of an LDO regulator 200 with pre-charge circuitry and a voltage clamp, in accordance with some embodiments. The LDO regulator 200 includes a differential amplifier 210, a pre-charge circuit 220, a voltage clamp 230, and a ballast transistor MB. The LDO regulator 200 may be an example embodiment of the LDO regulator 100 of FIG. 1. For example, the ballast transistor MB and differential amplifier 210 may be example embodiments of the pass element 110 and error amplifier 120, respectively, of FIG. 1. Furthermore, the pre-charge circuit 220 and voltage clamp 230 may correspond to at least part of the ICP circuitry 130 of FIG. 1. The LDO regulator 200 may be configured to produce a relatively stable output voltage Vₒᵤₜ based on an input voltage. In the example of FIG. 2, the input voltage may be provided by a voltage supply rail (V_{DD}) which may also provide power to other components of the device on which the LDO regulator 200 operates.

During normal operation, the ballast transistor MB may pass an output current Iₒᵤₜ from the voltage supply rail V_{DD} to the output of the LDO regulator 200. In the example of FIG. 2, the ballast transistor MB is depicted as a P-channel MOSFET (PMOS). However, in actual implementations, the ballast transistor MB may be implemented as one or more other types of transistors including, for example, an N-channel MOSFT (NMOS) and/or BJT. The ballast transistor MB may provide a drop out voltage between the input voltage (V_{DD}) and the output voltage Vₒᵤₜ of the LDO regulator 200. For example, the source of the ballast transistor MB may be coupled to the voltage supply rail V_{DD} and the drain of the ballast transistor MB may be coupled to the output terminal (e.g., Vₒᵤₜ) of the LDO regulator 200. Specifically, the ballast transistor MB may operate in the linear region to drop the input voltage V_{DD} down to the desired output voltage Vₒᵤₜ.

The differential amplifier 210 may adjust the resistance (or impedance) of the ballast transistor MB to maintain the output voltage Vₒᵤₜ at the desired voltage level. For example, the inverting (−) input of the differential amplifier 210 may be coupled to receive a reference voltage V_{ref} and the non-inverting (+) input of the differential amplifier 210 may be coupled to receive a feedback voltage V_{FB} that is representative of the output voltage Vₒᵤₜ. In the example of FIG. 2, the output voltage Vₒᵤₜ is provided across a voltage divider (e.g., corresponding to a series of resistors R1 and R2, which may be trimmable) and the feedback voltage V_{FB} corresponds to a center tap of the voltage divider. During normal operation, the reference voltage V_{ref} may be a steady voltage provided by a bandgap voltage reference (not shown for simplicity). The differential amplifier 210 compares the reference voltage V_{ref} to the feedback voltage V_{FB} and outputs a gate voltage V_{G} based on the difference between the voltages V_{ref} and V_{FB}.

The gate voltage V_{G} controls the resistance of the ballast transistor MB. For example, as the gate voltage V_{G} decreases, the resistance across the transistor MB (e.g., from source to drain) also decreases. Similarly, as the gate voltage V_{G} increases, the resistance across the transistor MB also increases. Accordingly, the differential amplifier 210 may adjust the gate voltage V_{G}, based on feedback from the output of the LDO regulator 200 (e.g., in the form of the feedback voltage V_{FB}), to maintain the output voltage Vₒᵤₜ at the desired voltage level. More specifically, the differential amplifier 210 may adjust the gate voltage V_{G}, in response to variations in the input voltage V_{DD} and/or a load impedance (not shown for simplicity) coupled to the output of the LDO regulator 200, to maintain a constant and steady output voltage Vₒᵤₜ.

For example, the differential amplifier 210 may increase the gate voltage V_{G} when the feedback voltage V_{FB} rises (e.g., corresponding to an increase in the output current Iₒᵤₜ) to increase the resistance of the ballast transistor MB, thereby reducing the flow of current through the transistor MB. Similarly, the differential amplifier 210 may decrease the gate voltage V_{G} when the feedback voltage V_{FB} drops (e.g., corresponding to a decrease in the output current Iₒᵤₜ) to decrease the resistance of the ballast transistor MB, thereby increasing the flow of current through the transistor MB.

As described above, a capacitor Cₒᵤₜ may be coupled to the output of the LDO regulator 200 to filter and/or maintain the output voltage Vₒᵤₜ. For example, when charged, the capacitor Cₒᵤₜ may resist large instantaneous changes in the output current Iₒᵤₜ. However, the capacitor Cₒᵤₜ may be initially discharged (e.g., to 0V) prior to powering on the LDO regulator 200. Thus, during device power-up, the capacitor Cₒᵤₜ may act as a shunt, drawing a substantial amount of in-rush current from the input voltage V_{DD}. As described above, a sufficiently large surge of in-rush current may collapse the power supply grid on which the LDO regulator 200 operates.

In some embodiments, the pre-charge circuit 220 may pre-charge the capacitor Cₒᵤₜ to a predetermined level prior to initiating normal operation of the LDO regulator 200. Specifically, the pre-charge circuit 220 may pre-charge the capacitor Cₒᵤₜ to a threshold voltage potential that is just below the desired output voltage Vₒᵤₜ for the LDO regulator 200 in order to reduce the voltage difference across the ballast transistor MB, and thus reduce the surge of in-rush current during device power-up. For example, the pre-charge circuit 220 may suppress or ground the reference voltage V_{ref} provided to the inverting input of the differential amplifier 210 to prevent the output of the differential amplifier 210 from turning on the ballast transistor MB. While the ballast transistor MB is turned off (and is not affected by the feedback voltage V_{FB}), the pre-charge circuit 220 may provide a pre-charge current I_{PC} to the capacitor Cₒᵤₜ until the voltage across the capacitor reaches the threshold voltage potential. In some aspects, the pre-charge current I_{PC} may be supplied by the voltage supply rail V_{DD}.

Still further, in some embodiments, the voltage clamp 230 may throttle the flow of current through the ballast transistor MB while charging the capacitor Cₒᵤₜ to the desired output voltage Vₒᵤₜ. Specifically, the voltage clamp 230 may maintain the resistance of the ballast transistor MB at a relatively high level until the capacitor Cₒᵤₜ is charged to the desired output voltage Vₒᵤₜ. For example, once the capacitor Cₒᵤₜ has been pre-charged to the threshold voltage potential, the pre-charge circuit 220 may suppress the pre-charge current I_{PC} and provide the normal reference voltage V_{ref} to the inverting input of the differential amplifier 210. This allows the differential amplifier 210 to begin adjusting the gate voltage V_{G} based on the feedback voltage V_{FB}. However, in some embodiments, the voltage clamp 230 may ensure that the gate voltage V_{G} does not drop below a predetermined voltage level. For example, the predetermined voltage level may prevent the ballast transistor MB from fully turning on (e.g., even when the voltages V_{ref} and V_{FB} are substantially equal), thus throttling the flow of current through the ballast transistor. In some aspects, the voltage clamp 230 may pull up the gate voltage V_{G} using the voltage supply rail V_{DD}.

When the capacitor Cₒᵤₜ has been charged to the desired output voltage Vₒᵤₜ, the voltage clamp 230 may be decoupled from the gate of the ballast transistor MB. Thereafter, the LDO regulator 200 may resume normal operation (e.g., by adjusting the resistance of the ballast transistor MB in response to changes in the feedback voltage V_{FB}). In other words, control of the ballast transistor MB is returned to the differential amplifier 210. By pre-charging the capacitor Cₒᵤₜ to a threshold voltage potential, the pre-charge circuit 220 may prevent the LDO regulator 200 from drawing a large surge of in-rush current during device power-up. Moreover, by clamping the gate voltage V_{G} to a predetermined voltage level, the voltage clamp 230 may further limit the flow of output current Iₒᵤₜ while charging the capacitor Cₒᵤₜ to the desired output voltage Vₒᵤₜ.

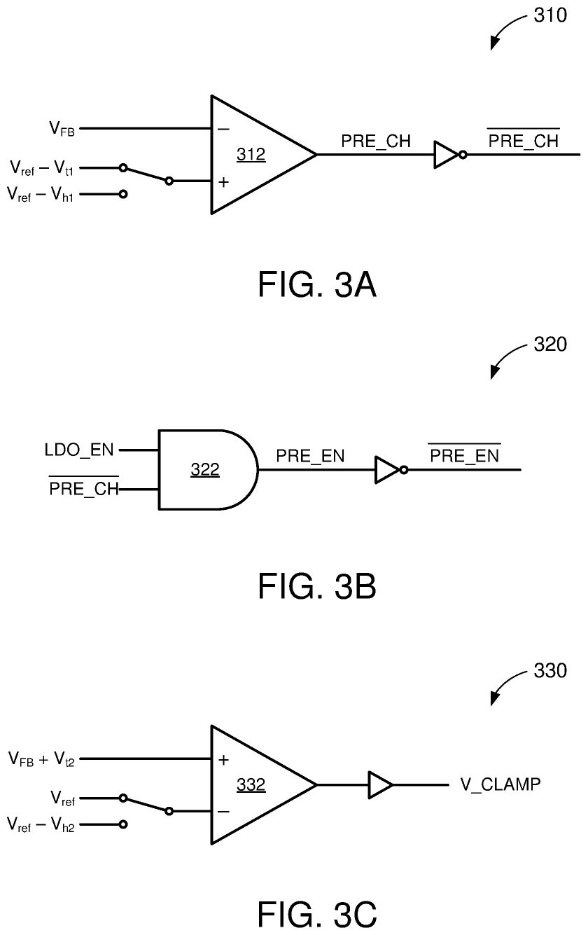

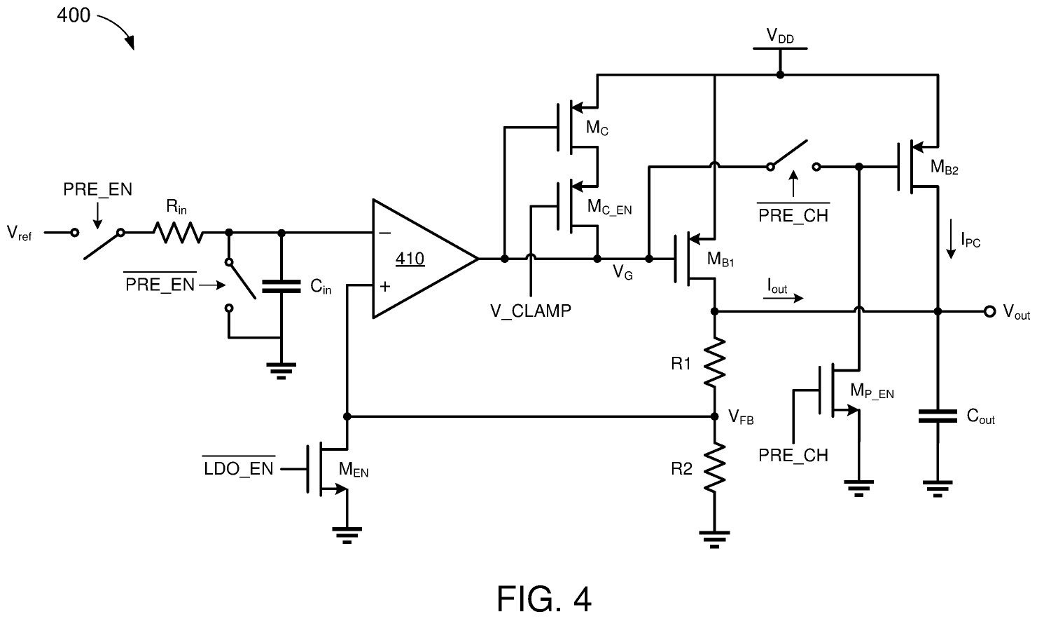

FIG. 3A shows an example LDO pre-charge controller 310, in accordance with some embodiments. With reference for example to FIG. 2, the LDO pre-charge controller 310 may control an operation of the pre-charge circuit 220 to pre-charge the capacitor Cₒᵤₜ to a threshold voltage potential. More specifically, the LDO pre-charge controller 310 may generate a set of control signals PRE_CH and P̅R̅E̅_̅C̅H̅ that may be used to activate and/or deactivate one or more components of the pre-charge circuit 220 (e.g., as described in greater detail below with respect to FIG. 4).

In the example of FIG. 3A, the LDO pre-charge controller 310 comprises a comparator 312 having a first (−) input coupled to receive a feedback voltage V_{FB} and a second (+) input coupled to receive a comparison voltage (V_{ref}−Vₜ₁) or a hysteresis voltage (V_{ref}−Vₕ₁). With reference for example to FIG. 2, the comparison voltage may be configured such that a voltage (V_{C}) across the capacitor Cₒᵤₜ is a threshold potential lower than the desired output voltage Vₒᵤₜ when the feedback voltage V_{FB} is equal to the comparison voltage

$$( e . g . , {V}_{C} = ( 1 + \frac{R 1}{R 2} ) ( {V}_{ref} - {V}_{t 1} ) , where \\ {V}_{out} = ( 1 + \frac{R 1}{R 2} ) {V}_{ref}$$

and Vₜ₁ represents a threshold voltage potential). Thus, when the feedback voltage V_{FB} is less than the comparison voltage (e.g., V_{FB}<V_{ref}−Vₜ₁), the comparator 312 outputs PRE_CH in a logic-high state (and P̅R̅E̅_̅C̅H̅ is asserted to a logic-low state). However, when the feedback voltage V_{FB} is greater than or equal to the comparison voltage (e.g., V_{FB}≥V_{ref}−Vₜ₁), the comparator 312 may output PRE_CH in a logic-low state (and P̅R̅E̅_̅C̅H̅ is asserted to a logic-high state).

In some embodiments, the LDO pre-charge controller 310 may enable hysteresis once the feedback voltage V_{FB} reaches or exceeds the comparison voltage. For example, when the feedback voltage V_{FB} is greater than or equal to the comparison voltage (e.g., V_{FB}≥V_{ref}−Vₜ₁), the second input of the comparator 312 may switch to the hysteresis voltage (e.g., V_{ref}−Vₕ₁, where Vₕ₁>Vₜ₁). The hysteresis voltage may be configured to prevent the output of the comparator 312 from oscillating in response to slight voltage fluctuations in the feedback voltage V_{FB} when the feedback voltage V_{FB} is substantially equal to the comparison voltage (e.g., V_{FB}=V_{ref}−Vₜ₁).

FIG. 3B shows an example LDO pre-enable controller 320, in accordance with some embodiments. With reference for example to FIG. 2, the LDO pre-enable controller 320 may control an operation of the differential amplifier 210 and the voltage clamp 230 to charge the capacitor Cₒᵤₜ to the desired output voltage Vₒᵤₜ. More specifically, the LDO pre-enable controller 320 may generate a set of control signals PRE_EN and P̅R̅E̅_̅E̅N̅ that may be used to activate and/or deactivate the differential amplifier 210 (e.g., as described in greater detail below with respect to FIG. 4).

In the example of FIG. 3B, the LDO pre-enable controller 320 comprises a logic gate 322 having a first input coupled to receive an LDO enable signal (LDO_EN) and a second input coupled to receive P̅R̅E̅_̅C̅H̅ (e.g., from the LDO pre-charge controller 310). More specifically, LDO_EN may be asserted to a logic-high state when the LDO regulator is powered on or activated. As described above, P̅R̅E̅_̅C̅H̅ is asserted to a logic-high state when the capacitor Cₒᵤₜ has been pre-charged to a threshold voltage potential. In some embodiments, the logic gate 322 may output PRE_EN as a logic AND combination of the input signals LDO_EN and P̅R̅E̅_̅C̅H̅. Thus, the logic gate 322 may output PRE_EN in a logic-high state (and P̅R̅E̅_̅E̅N̅ is asserted to a logic-low state) only after the LDO regulator has been powered on and the capacitor Cₒᵤₜ has been pre-charged to the threshold voltage potential. However, if the LDO regulator is not yet powered on or the capacitor Cₒᵤₜ has not been pre-charged to the threshold voltage potential, the logic gate 322 may output PRE_EN in a logic-low state (and P̅R̅E̅_̅E̅N̅ is asserted to a logic-high state).

FIG. 3C shows an example LDO voltage clamp controller 330, in accordance with some embodiments. With reference for example to FIG. 2, the LDO voltage clamp controller 330 may control an operation of the voltage clamp 230 to limit the flow of output current Iₒᵤₜ while charging the capacitor Cₒᵤₜ to the desired output voltage Vₒᵤₜ. More specifically, the LDO voltage clamp controller 330 may generate a control signal V_CLAMP that may be used to activate and/or deactivate the voltage clamp 230 (e.g., as described in greater detail below with respect to FIG. 4).

In the example of FIG. 3C, the LDO voltage clamp controller 330 comprises a comparator 332 having a first (+) input coupled to receive a comparison voltage (V_{FB}+Vₜ₂) and a second (−) input coupled to receive a reference voltage V_{ref} or a hysteresis voltage (V_{ref}−Vₕ₂). With reference for example to FIG. 2, the comparison voltage may be configured such that a voltage (V_{C}) across the capacitor Cₒᵤₜ is a threshold potential lower than the desired output voltage Vₒᵤₜ when the reference voltage V_{ref} is equal to the comparison voltage

$$( e . g . , {V}_{C} = ( 1 + \frac{R 1}{R 2} ) ( {V}_{ref} - {V}_{t 2} ) , where \\ {V}_{out} = ( 1 + \frac{R 1}{R 2} ) {V}_{ref}$$

and Vₜ₂ represents a threshold voltage potential). Thus, when the reference voltage V_{ref} is less than or equal to the comparison voltage (e.g., V_{ref}≤V_{FB}+Vₜ₂), the comparator 332 outputs V_CLAMP in a logic-high state (e.g., after some delay). However, when the reference voltage V_{ref} is greater than the comparison voltage (e.g., V_{ref}>V_{FB}+Vₜ₂), the comparator 332 may output V_CLAMP in a logic-low state (e.g., after some delay).

In some embodiments, the LDO voltage clamp controller 330 may enable hysteresis once the reference voltage V_{ref} reaches or exceeds the comparison voltage. For example, when the reference voltage V_{ref} is less than or equal to the comparison voltage (e.g., V_{ref}≤V_{FB}+Vₜ₂), the second input of the comparator 332 may switch to the hysteresis voltage (e.g., V_{ref}−Vₕ₂, where Vₕ₂>0). The hysteresis voltage may be configured to prevent the output of the comparator 332 from oscillating in response to slight voltage fluctuations in the feedback voltage V_{FB} when the comparison voltage is substantially equal to the reference voltage V_{ref} (e.g., V_{ref}=V_{FB}+Vₜ₂).

FIG. 4 is a circuit diagram of an LDO regulator 400 with in-rush current protection circuitry, in accordance with some embodiments. The LDO regulator 400 includes a differential amplifier 410 and a set of ballast transistors M_{B1} and M_{B2}. The LDO regulator 400 may be an example embodiment of the LDO regulator 100 of FIG. 1 and/or LDO regulator 200 of FIG. 2. For example, the ballast transistors M_{B1} and M_{B2} may be example embodiments of the pass element 110 and the differential amplifier 410 may be an example embodiment of the error amplifier 120 of FIG. 1. The LDO regulator 400 may be configured to produce a relatively stable output voltage Vₒᵤₜ based on an input voltage. In the example of FIG. 4, the input voltage may be provided by a voltage supply rail (V_{DD}) which may also provide power to other components of the device on which the LDO regulator 400 operates.

In some embodiments, the LDO regulator 400 may include an LDO enable transistor M_{EN} which may be used to turn the LDO regulator 400 on and/or off. In the example of FIG. 4, the LDO enable transistor M_{EN} is depicted as an NMOS transistor having a drain coupled to the feedback path of the differential amplifier 410 and a source coupled to ground. The gate of the LDO enable transistor M_{EN} is coupled to receive L̅D̅O̅_̅E̅N̅. Thus, when L̅D̅O̅_̅E̅N̅is in a logic-high state (e.g., indicating that the LDO regulator 400 is powered off), the transistor M_{EN} is turned on to prevent operation of the LDO regulator 400. However, when L̅D̅O̅_̅E̅N̅is in a logic-low state (e.g., indicating that the LDO regulator 400 is powered on), the transistor M_{EN} is turned off to enable normal operation of the LDO regulator 400.

During normal operation, the ballast transistors M_{B1} and M_{B2} may pass an output current Iₒᵤₜ from the voltage supply rail V_{DD} to the output of the LDO regulator 400. In the example of FIG. 4, the ballast transistors M_{B1} and M_{B2} are depicted as PMOS transistors. However, in actual implementations, the ballast transistors M_{B1} and M_{B2} may be implemented as one or more other types of transistors including, for example, NMOS transistors and/or BJTs. The ballast transistors M_{B1} and M_{B2} may provide a drop in voltage between the input voltage (V_{DD}) and the output voltage Vₒᵤₜ of the LDO regulator 400. For example, the sources of the ballast transistors M_{B1} and M_{B2} may be coupled to the voltage supply rail V_{DD} and the drains of the ballast transistors M_{B1} and M_{B2} may be coupled to the output terminal (e.g., Vₒᵤₜ) of the LDO regulator 400. Specifically, the ballast transistors M_{B1} and M_{B2} may operate in the linear region to drop the input voltage V_{DD} down to the desired output voltage Vₒᵤₜ.

The differential amplifier 410 may adjust the resistance (or impedance) of the ballast transistors M_{B1} and M_{B2} to maintain the output voltage Vₒᵤₜ at the desired voltage level. In some embodiments, the inverting (−) input of the differential amplifier 410 is switchably coupled to receive a reference voltage V_{ref} and the non-inverting (+) input of the differential amplifier 410 is coupled to receive a feedback voltage V_{FB} that is representative of the output voltage Vₒᵤₜ. In the example of FIG. 4, the output voltage Vₒᵤₜ is provided across a voltage divider network (e.g., comprising a series of resistors R1 and R2, which may be trimmable) and the feedback voltage V_{FB} corresponds to a center (or other fractional) tap of the voltage divider. The reference voltage V_{ref} may be a steady voltage provided by a bandgap voltage reference (not shown for simplicity). During normal operation, the differential amplifier 410 compares the reference voltage V_{ref} to the feedback voltage V_{FB} and outputs a gate voltage V_{G} based on the difference between the voltages V_{ref} and V_{FB}.

As described above, the gate voltage V_{G} controls the resistance of the ballast transistors M_{B1} and M_{B2}. Furthermore, the differential amplifier 410 may adjust the gate voltage V_{G}, based on feedback from the output of the LDO regulator 400 (e.g., in the form of the feedback voltage V_{FB}), to maintain the output voltage Vₒᵤₜ at the desired voltage level. More specifically, the differential amplifier 410 may adjust the gate voltage V_{G}, in response to variations in the input voltage V_{DD} and/or a load impedance (not shown for simplicity) coupled to the output of the LDO regulator 400, to maintain a constant and steady output voltage Vₒᵤₜ. For example, the differential amplifier 410 may increase the gate voltage V_{G} when the feedback voltage V_{FB} rises to increase the resistance of the ballast transistors M_{B1} and M_{B2}, thereby reducing the flow of output current Iₒᵤₜ. Similarly, the differential amplifier 410 may decrease the gate voltage V_{G} when the feedback voltage V_{FB} drops to decrease the resistance of the ballast transistors M_{B1} and M_{B2}, thereby increasing the flow of output current Iₒᵤₜ.

A capacitor Cₒᵤₜ may be coupled to the output of the LDO regulator 400 to filter and/or maintain the output voltage Vₒᵤₜ. For example, when charged, the capacitor Cₒᵤₜ may resist large instantaneous changes in the output current Iₒᵤₜ. However, the capacitor Cₒᵤₜ may be initially discharged (e.g., to 0V) prior to powering on the LDO regulator 400. Thus, during device power-up, the capacitor Cₒᵤₜ may act as a shunt, drawing a substantial amount of in-rush current from the input voltage V_{DD}. As described above, a sufficiently large surge of in-rush current may collapse the power supply grid on which the LDO regulator 400 operates.

In some embodiments, the LDO regulator 400 may include pre-charge circuitry to pre-charge the capacitor Cₒᵤₜ to a predetermined level prior to initiating normal operation of the LDP regulator 400. Specifically, the pre-charge circuitry may pre-charge the capacitor Cₒᵤₜ to a threshold voltage potential that is just below the desired output voltage Vₒᵤₜ for the LDO regulator 400 in order to reduce the voltage difference across the ballast transistor MB, and thus reduce the surge of in-rush current during device power-up. In the example of FIG. 4, the pre-charge circuitry may include the LDO pre-charge controller 310 of FIG. 3A, the LDO pre-enable controller 320 of FIG. 3B, and a pre-charge transistor M_{P_EN} that controls a flow of charge to the capacitor Cₒᵤₜ via one of the ballast transistors (e.g., M_{B2}).

When PRE_CH is in a logic-high state, PRE_EN is in a logic-low state and P̅R̅E̅_̅E̅N̅ is in a logic-high state. As a result, the inverting input of the differential amplifier 410 is shorted to ground, the gate of the second ballast transistor M_{B2} is decoupled from the differential amplifier 410, and the pre-charge transistor M_{P_EN} is turned on. In this configuration, the pre-charge transistor M_{P_EN} (rather than the differential amplifier 410) controls the gate of the second ballast transistor M_{B2}. More specifically, the pre-charge transistor M_{P_EN} may be configured to turn on the second ballast transistor M_{B2} to provide a pre-charge current I_{PC} to the capacitor Cₒᵤₜ. In some embodiments, the voltage drop across the pre-charge transistor M_{P_EN} may be used to control the flow of pre-charge current I_{PC}, for example, to ensure that the pre-charge current I_{PC} is below a certain threshold (e.g., to prevent a surge of in-rush current). The pre-charge transistor M_{P_EN} may then stop the flow of pre-charge current I_{PC} through the second ballast transistor M_{B2} when PRE_CH is driven to a logic-low state. As described above with respect to FIG. 3A, PRE_CH may be driven to a logic-low state when the voltage across the capacitor Cₒᵤₜ reaches a first threshold voltage potential

$$( e . g . , {V}_{C} = ( 1 + \frac{R 1}{R 2} ) ( {V}_{ref} - {V}_{t 1} ) ) .$$

In some embodiments, the LDO regulator 400 may further include voltage clamping circuitry to throttle the flow of current through the ballast transistors M_{B1} and M_{B2} while charging the capacitor Cₒᵤₜ to the desired output voltage Vₒᵤₜ. Specifically, the voltage clamping circuitry may maintain the resistance of the ballast transistors M_{B1} and M_{B2} at a relatively high level until the capacitor Cₒᵤₜ is charged to the desired output voltage Vₒᵤₜ. In the example of FIG. 4, the voltage clamping circuitry may include the LDO pre-enable controller 320 of FIG. 3B, the LDO voltage clamp controller 330 of FIG. 3C, and a set of voltage clamp transistors M_{C} and M_{C_EN} which selectively control the gate voltage V_{G} provided to the ballast transistors M_{B1} and M_{B2}.

As described above with respect to FIG. 3B, PRE_EN is driven to a logic-high state when PRE_CH is driven to a logic-low state (and LDO_EN remains in a logic-high state). When PRE_EN is in a logic-high state and P̅R̅E̅_̅E̅N̅is in a logic-low state, the inverting input of the differential amplifier 410 is coupled to the reference voltage V_{ref}, the gate of the second ballast transistor M_{B2} is coupled to the output of the differential amplifier 410, and the pre-charge transistor M_{P_EN} is turned off. In some embodiments, the reference voltage V_{ref} may be coupled to the inverting input of the differential amplifier 410 through a low-pass filter (e.g., Rᵢₙ and Cᵢₙ), which may filter noise and/or other variations in the reference voltage V_{ref}. Thus, while the voltage at the inverting input of the differential amplifier 410 (e.g., provided by V_{ref}) slowly rises, the feedback voltage V_{FB} (which is already pre-charged to a threshold voltage potential) may exceed the voltage at the inverting input of the differential amplifier 410. As the voltages at the inputs of the differential amplifier 510 approach one another, the voltage at the output of the differential amplifier 510 may drop. However, as described above with respect to FIG. 3C, while the feedback voltage V_{FB}+Vₜ₂ is below the reference voltage V_{ref} (e.g., V_{FB}+Vₜ₂<V_{ref}), V_CLAMP may be in a logic-low state.

When V_CLAMP is in a logic-low state, the transistor M_{C_EN} is turned on to couple the voltage clamp transistor M_{C} to the gates of the ballast transistors M_{B1} and M_{B2}. More specifically, as the voltages at the inputs of the differential amplifier 410 approach one another, the voltage at the output of the differential amplifier 410 may drop, thus pulling down the gate voltage V_{G} and turning on the ballast transistors M_{B1} and M_{B2}. However, the voltage clamp transistors M_{C} and M_{C_EN} may ensure that the gate voltage V_{G} does not drop too far below a threshold voltage level, for example, to prevent ballast transistors M_{B1} and M_{B2} from fully turning on. In some embodiments, the resistance across the voltage clamp transistors M_{C} and M_{C_EN} may be lower than the output impedance of the differential amplifier 410. Thus, the voltage clamp transistors M_{C} and M_{C_EN} may hold the gate voltage V_{G} at the threshold voltage level (e.g., V_{DD}−(V_{GS} of M_{C})), preventing the voltage at the output of the differential amplifier 410 from dropping. Accordingly, the voltage clamp transistors M_{C} and M_{C_EN} may throttle the flow of output current Iₒᵤₜ through the ballast transistors M_{B1} and M_{B2} while the differential amplifier 410 reaches a steady state and the capacitor Cₒᵤₜ is charged to the desired output voltage Vₒᵤₜ.

As described above with respect to FIG. 3C, V_CLAMP may be driven to a logic-high state when the voltage across the capacitor Cₒᵤₜ reaches a second threshold voltage potential

$$( e . g . , {V}_{C} = ( 1 + \frac{R 1}{R 2} ) ( {V}_{ref} - {V}_{t 2} ) ) .$$

When V_CLAMP is in a logic-high state, the transistor M_{C_EN} is turned off and the voltage clamp transistor M_{C} is decoupled from the gates of the ballast transistors M_{B1} and M_{B2}. As a result, control of the gate voltage V_{G} is returned to the differential amplifier 410 (e.g., the voltage clamp transistors M_{C} and M_{C_EN} no longer have control of the gate voltage V_{G}). Once control of the gate voltage V_{G} has been returned to the differential amplifier 410, the LDO regulator 400 may resume normal operation (e.g., as described above).

It is noted that, while the voltage clamp transistors M_{C} and M_{C_EN} may throttle the flow of output current Iₒᵤₜ via the ballast transistors M_{B1} and M_{B2}, the output current Iₒᵤₜ may jump when the voltage clamp transistors M_{C} and M_{C_EN} release control of the gate voltage V_{G} back to the differential amplifier 410 (e.g., when V_CLAMP is asserted to a logic-high state). In some embodiments, to prevent sudden jumps in the output current Iₒᵤₜ, control of the gate voltage V_{G} may be gradually returned to the differential amplifier 410 via multiple successive stages of voltage clamp transistors. For example, each successive stage of voltage clamp transistors may release its control over the gate voltage V_{G} in sequence (e.g., at different times), until the output current Iₒᵤₜ is locked to the output of the differential amplifier 410.

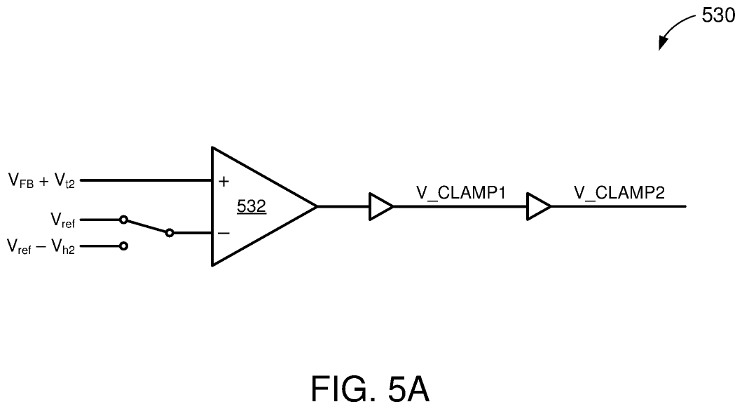

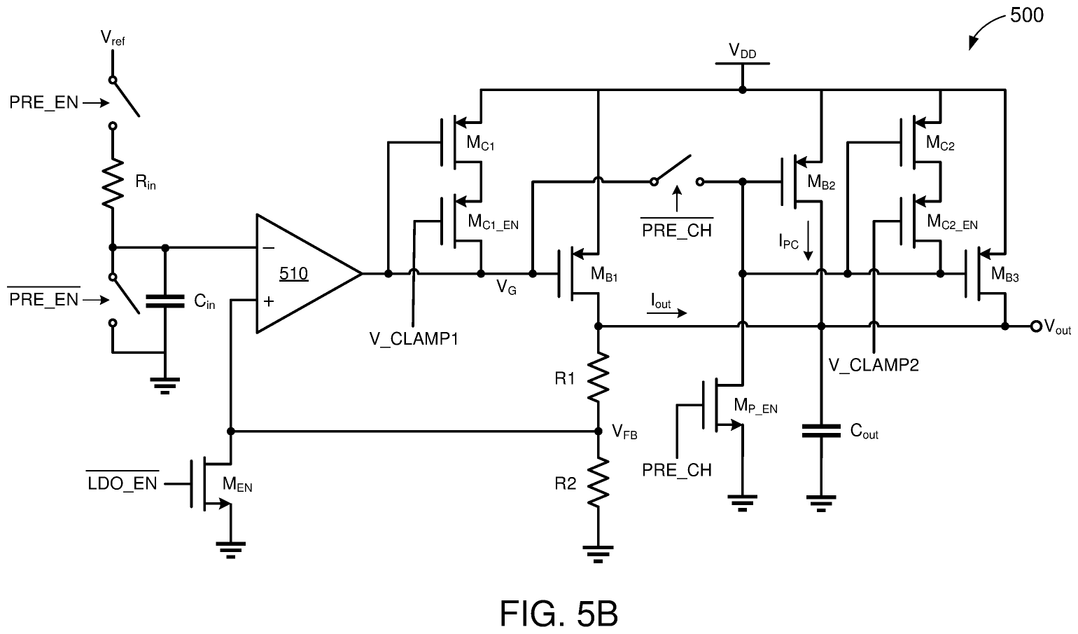

FIG. 5A shows another example LDO voltage clamp controller 530, in accordance with some embodiments. The LDO voltage clamp controller 530 may control multiple stages of voltage clamp transistors to limit the flow of output current Iₒᵤₜ of an LDO regulator while charging a capacitor Cₒᵤₜ to a desired output voltage Vₒᵤₜ. More specifically, the LDO voltage clamp controller 530 may generate a plurality of control signals V_CLAMP1 and V_CLAMP2 that may be used to activate and/or deactivate respective stages of voltage clamp transistors (e.g., as described in greater detail below with respect to FIG. 5B).

In the example of FIG. 5A, the LDO voltage clamp controller 530 comprises a comparator 532 having a first (+) input coupled to receive a comparison voltage (V_{FB}+Vₜ₂) and a second (−) input coupled to receive a reference voltage V_{ref} or a hysteresis voltage (V_{ref}−Vₕ₂). With reference for example to FIG. 2, the comparison voltage may be configured such that a voltage (V_{C}) across the capacitor Cₒᵤₜ is a threshold potential lower than the desired output voltage Vₒᵤₜ when the reference voltage V_{ref} is equal to the comparison voltage

$$( e . g . , {V}_{C} = ( 1 + \frac{R 1}{R 2} ) ( {V}_{ref} - {V}_{t 2} ) , where \\ {V}_{out} = ( 1 + \frac{R 1}{R 2} ) {V}_{ref}$$

and Vₜ₂ represents a threshold voltage potential). Thus, when the reference voltage V_{ref} is greater than or equal to the comparison voltage (e.g., V_{ref}≥V_{FB}+Vₜ₂), the comparator 532 outputs V_CLAMP1 and V_CLAMP2 in a logic-low state. However, when the reference voltage V_{ref} is less than the comparison voltage (e.g., V_{ref}<V_{FB}+Vₜ₂), the comparator 532 may output V_CLAMP1 in a logic-high state after some delay and may output V_CLAMP2 in a logic-high state after some further delay. Accordingly, the LDO voltage clamp controller 530 may stagger the transitions of V_CLAMP1 and V_CLAMP2.

In some embodiments, the LDO voltage clamp controller 530 may enable hysteresis once the reference voltage V_{ref} reaches or exceeds the comparison voltage. For example, when the reference voltage V_{ref} is greater than or equal to the comparison voltage (e.g., V_{ref}≥V_{FB}+Vₜ₂), the second input of the comparator 532 may switch to the hysteresis voltage (e.g., V_{ref}−Vₕ₂, where Vₕ₂>0). The hysteresis voltage may be configured to prevent the output of the comparator 532 from oscillating in response to slight voltage fluctuations in the feedback voltage V_{FB} when the comparison voltage is substantially equal to the reference voltage V_{ref} (e.g., V_{ref}=V_{FB}+Vₜ₂).

FIG. 5B is another circuit diagram of an LDO regulator 500 with in-rush current protection circuitry, in accordance with some other embodiments. The LDO regulator 500 includes a differential amplifier 510 and a set of ballast transistors M_{B1}-M_{B3}. The LDO regulator 500 may be an example embodiment of the LDO regulator 100 of FIG. 1 and/or LDO regulator 200 of FIG. 2. For example, the ballast transistors M_{B1}-M_{B3} may be example embodiments of the pass element 110 and the differential amplifier 510 may be an example embodiment of the error amplifier 120 of FIG. 1. The LDO regulator 500 may be configured to produce a relatively stable output voltage Vₒᵤₜ based on an input voltage. In the example of FIG. 5B, the input voltage may be provided by a voltage supply rail (V_{DD}) which may also provide power to other components of the device on which the LDO regulator 500 operates.

In some embodiments, the LDO regulator 500 may include an LDO enable transistor M_{EN} which may be used to turn the LDO regulator 500 on and/or off. In the example of FIG. 5B, the LDO enable transistor M_{EN} is depicted as an NMOS transistor having a drain coupled to the feedback path of the differential amplifier 510 and a source coupled to ground. The gate of the LDO enable transistor M_{EN} is coupled to receive L̅D̅O̅_̅E̅N̅. Thus, when L̅D̅O̅_̅E̅N̅is in a logic-high state (e.g., indicating that the LDO regulator 500 is powered off), the transistor M_{EN} is turned on to prevent operation of the LDO regulator 500. However, when L̅D̅O̅_̅E̅N̅is in a logic-low state (e.g., indicating that the LDO regulator 500 is powered on), the transistor M_{EN} is turned off to enable normal operation of the LDO regulator 500.

During normal operation, the ballast transistors M_{B1}-M_{B3} may pass an output current Iₒᵤₜ from the voltage supply rail V_{DD} to the output of the LDO regulator 500. In the example of FIG. 5B, the ballast transistors M_{B1}-M_{B3} are depicted as PMOS transistors. However, in actual implementations, the ballast transistors M_{B1}-M_{B3} may be implemented as one or more other types of transistors including, for example, NMOS transistors and/or BJTs. The ballast transistors M_{B1}M_{B3} may provide a drop in voltage between the input voltage (V_{DD}) and the output voltage Vₒᵤₜ of the LDO regulator 500. For example, the sources of the ballast transistors M_{B1}-M_{B3} may be coupled to the voltage supply rail V_{DD} and the drains of the ballast transistors M_{B1}M_{B3} may be coupled to the output terminal (e.g., Vₒᵤₜ) of the LDO regulator 500. Specifically, the ballast transistors M_{B1}-M_{B3} may operate in the linear region to drop the input voltage V_{DD} down to the desired output voltage Vₒᵤₜ.

The differential amplifier 510 may adjust the resistance (or impedance) of the ballast transistors M_{B1}-M_{B3} to maintain the output voltage Vₒᵤₜ at the desired voltage level. In some embodiments, the inverting (−) input of the differential amplifier 510 is switchably coupled to receive a reference voltage V_{ref} and the non-inverting (+) input of the differential amplifier 510 is coupled to receive a feedback voltage V_{FB} that is representative of the output voltage Vₒᵤₜ. In the example of FIG. 5B, the output voltage Vₒᵤₜ is provided across a voltage divider network (e.g., comprising a series of resistors R1 and R2, which may be trimmable) and the feedback voltage V_{FB} corresponds to a center (or other fractional) tap of the voltage divider. The reference voltage V_{ref} may be a steady voltage provided by a bandgap voltage reference (not shown for simplicity). During normal operation, the differential amplifier 510 compares the reference voltage V_{ref} to the feedback voltage V_{FB} and outputs a gate voltage V_{G} based on the difference between the voltages V_{ref} and V_{FB}.

As described above, the gate voltage V_{G} controls the resistance of the ballast transistors M_{B1}-M_{B3}. Furthermore, the differential amplifier 510 may adjust the gate voltage V_{G}, based on feedback from the output of the LDO regulator 500 (e.g., in the form of the feedback voltage V_{FB}), to maintain the output voltage Vₒᵤₜ at the desired voltage level. More specifically, the differential amplifier 510 may adjust the gate voltage V_{G}, in response to variations in the input voltage V_{DD} and/or a load impedance (not shown for simplicity) coupled to the output of the LDO regulator 500, to maintain a constant and steady output voltage Vₒᵤₜ. For example, the differential amplifier 510 may increase the gate voltage V_{G} when the feedback voltage V_{FB} rises to increase the resistance of the ballast transistors M_{B1}-M_{B3}, thereby reducing the flow of output current Iₒᵤₜ. Similarly, the differential amplifier 510 may decrease the gate voltage V_{G} when the feedback voltage V_{FB} drops to decrease the resistance of the ballast transistors M_{B1}M_{B3}, thereby increasing the flow of output current Iₒᵤₜ.

A capacitor Cₒᵤₜ may be coupled to the output of the LDO regulator 500 to filter and/or maintain the output voltage Vₒᵤₜ. For example, when charged, the capacitor Cₒᵤₜ may resist large instantaneous changes in the output current Iₒᵤₜ. However, the capacitor Cₒᵤₜ may be initially discharged (e.g., to 0V) prior to powering on the LDO regulator 500. Thus, during device power-up, the capacitor Cₒᵤₜ may act as a shunt, drawing a substantial amount of in-rush current from the input voltage V_{DD}. As described above, a sufficiently large surge of in-rush current may collapse the power supply grid on which the LDO regulator 500 operates.

In some embodiments, the LDO regulator 500 may include pre-charge circuitry to pre-charge the capacitor Cₒᵤₜ to a predetermined level prior to initiating normal operation of the LDO regulator 500. Specifically, the pre-charge circuitry may pre-charge the capacitor Cₒᵤₜ to a threshold voltage potential that is just below the desired output voltage Vₒᵤₜ for the LDO regulator 500 in order to reduce the voltage difference across the ballast transistor MB, and thus reduce the surge of in-rush current during device power-up. In the example of FIG. 5B, the pre-charge circuitry may include the LDO pre-charge controller 310 of FIG. 3A, the LDO pre-enable controller 320 of FIG. 3B, and a pre-charge transistor M_{P_EN} that controls a flow of charge to the capacitor Cₒᵤₜ via one or more of the ballast transistors (e.g., M_{B2} and M_{B3}).

When PRE_CH is in a logic-high state, PRE_EN is in a logic-low state and P̅R̅E̅_̅E̅N̅ is in a logic-high state. As a result, the inverting input of the differential amplifier 510 is shorted to ground, the gates of the ballast transistors M_{B2} and M_{B3} are decoupled from the differential amplifier 510, and the pre-charge transistor M_{P_EN} is turned on. In this configuration, the pre-charge transistor M_{P_EN} (rather than the differential amplifier 510) controls the gates of the ballast transistor M_{B2} and M_{B3}. More specifically, the pre-charge transistor M_{P_EN} may be configured to turn on the ballast transistors M_{B2} and M_{B3} to provide a pre-charge current I_{PC} to the capacitor Cₒᵤₜ. In some embodiments, the voltage drop across the pre-charge transistor M_{P_EN} may be used to control the flow of pre-charge current I_{PC}, for example, to ensure that the pre-charge current I_{PC} is below a certain threshold (e.g., to prevent a surge of in-rush current). The pre-charge transistor M_{P_EN} may then stop the flow of pre-charge current I_{PC} through the ballast transistors M_{B2} and M_{B3} when PRE_CH is driven to a logic-low state. As described above with respect to FIG. 3A, PRE_CH may be driven to a logic-low state when the voltage across the capacitor Cₒᵤₜ reaches a first threshold voltage potential

$$( e . g . , {V}_{C} = ( 1 + \frac{R 1}{R 2} ) ( {V}_{ref} - {V}_{t 1} ) ) .$$

In some embodiments, the LDO regulator 500 may further include voltage clamping circuitry to throttle the flow of current through the ballast transistors M_{B1}-M_{B3} while charging the capacitor Cₒᵤₜ to the desired output voltage Vₒᵤₜ. Specifically, the voltage clamping circuitry may maintain the resistance of the ballast transistors M_{B1}-M_{B3} at a relatively high level until the capacitor Cₒᵤₜ is charged to the desired output voltage Vₒᵤₜ. In the example of FIG. 5B, the voltage clamping circuitry may include the LDO pre-enable controller 320 of FIG. 3B, the LDO voltage clamp controller 530 of FIG. 5A, and a first stage of voltage clamp transistors M_{C1} and M_{C1_EN} and a second stage of voltage clamp transistors M_{C2} and M_{C2_EN} which selectively control the gate voltage V_{G} provided to the ballast transistors M_{B1}-M_{B3}.

As described above with respect to FIG. 3B, PRE_EN is driven to a logic-high state when PRE_CH is driven to a logic-low state (and LDO_EN remains in a logic-high state). When PRE_EN is in a logic-high state and P̅R̅E̅_̅E̅N̅is in a logic-low state, the inverting input of the differential amplifier 510 is coupled to the reference voltage V_{ref}, the gates of the ballast transistors M_{B2} and M_{B3} are coupled to the output of the differential amplifier 510, and the pre-charge transistor M_{P_EN} is turned off. In some embodiments, the reference voltage V_{ref} may be coupled to the inverting input of the differential amplifier 510 through a low-pass filter (e.g., Rᵢₙ and Cᵢₙ), which may filter noise and/or other variations in the reference voltage V_{ref}. Thus, while the voltage at the inverting input of the differential amplifier 510 (e.g., provided by V_{ref}) slowly rises, the feedback voltage V_{FB} (which is already pre-charged to a threshold voltage potential) may exceed the voltage at the inverting input of the differential amplifier 510. As the voltages at the inputs of the differential amplifier 510 approach one another, the voltage at the output of the differential amplifier 510 may drop. However, as described above with respect to FIG. 5A, while the feedback voltage V_{FB}+Vₜ₂ is below the reference voltage V_{ref} (e.g., V_{FB}+Vₜ₂<V_{ref}), V_CLAMP1 and V_CLAMP2 may be in a logic-low state.

When V_CLAMP1 and V_CLAMP2 are in a logic-low state, the transistors M_{C1_EN} and M_{C2_EN} are turned on to couple respective voltage clamp transistors M_{C1} and M_{C2} to the gates of the ballast transistors M_{B1}-M_{B3}. More specifically, as the voltages at the inputs of the differential amplifier 510 approach one another, the voltage at the output of the differential amplifier 510 may drop, thus pulling down the gate voltage V_{G} and turning on the ballast transistors M_{B1}-M_{B3}. However, the voltage clamp transistors M_{C1}/M_{C1_EN} and M_{C2}/M_{C2_EN} may ensure that the gate voltage V_{G} does not drop too far below a threshold voltage level, for example, to prevent ballast transistors M_{B1}-M_{B3} from fully turning on. In some embodiments, the resistance across the voltage clamp transistors M_{C1}/M_{C1_EN} and M_{C2}/M_{C2_EN} may be lower than the output impedance of the differential amplifier 510. Thus, the voltage clamp transistors M_{C1}/M_{C1_EN} and M_{C2}/M_{C2_EN} may hold the gate voltage V_{G} at the threshold voltage level (e.g., V_{DD}−(V_{GS} of M_{C1} or M_{C2})), preventing the voltage at the output of the differential amplifier 510 from dropping. Accordingly, the voltage clamp transistors M_{C1}/M_{C1_EN} and M_{C2}/M_{C2_EN} may throttle the flow of output current Iₒᵤₜ through the ballast transistors M_{B1}M_{B3} while the differential amplifier 510 reaches a steady state and the capacitor Cₒᵤₜ is charged to the desired output voltage Vₒᵤₜ.

As described above with respect to FIG. 5A, V_CLAMP1 and V_CLAMP2 may be driven to a logic-high state when the voltage across the capacitor Cₒᵤₜ reaches a second threshold voltage potential

$$( e . g . , {V}_{C} = ( 1 + \frac{R 1}{R 2} ) ( {V}_{ref} - {V}_{t 2} ) ) .$$

More specifically, when the voltage across the capacitor Cₒᵤₜ reaches the second threshold voltage potential, V_CLAMP1 first transitions to the logic-high state and, after some delay, V_CLAMP2 subsequently transitions to the logic-high state. When V_CLAMP1 is in a logic-high state, the transistor M_{C1_EN} is turned off and the voltage clamp transistor M_{C1} is decoupled from the gates of the ballast transistors M_{B1}-M_{B3}. This may reduce some amount of pull on the gate voltage V_{G} that was previously exerted by the first transistor stage M_{C1} and M_{C1_EN}. However, while V_CLAMP2 is still in the logic-low state, the second transistor stage M_{C2} and M_{C2_EN} may still exert some pull on the gate voltage V_{G}. Thus, when V_CLAMP1 initially transitions to the logic-high state (e.g., and V_CLAMP2 remains in the logic-low state), the gate voltage V_{G} may drop slightly toward the output voltage of the differential amplifier 510.

When V_CLAMP2 is in a logic-high state, the transistor M_{C2_EN} is turned off and the voltage clamp transistor M_{C2} is decoupled from the gates of the ballast transistors M_{B1}-M_{B3}. It is noted that, by the time V_CLAMP2 transitions to the logic-high state, V_CLAMP1 is already in the logic-high state. As a result, control of the gate voltage V_{G} is returned to the differential amplifier 510 (e.g., the voltage clamp transistors M_{C1}/M_{C1_EN} and M_{C2}/M_{C2_EN} no longer have control of the gate voltage V_{G}). Once control of the gate voltage V_{G} has been returned to the differential amplifier 510, the LDO regulator 500 may resume normal operation (e.g., as described above).

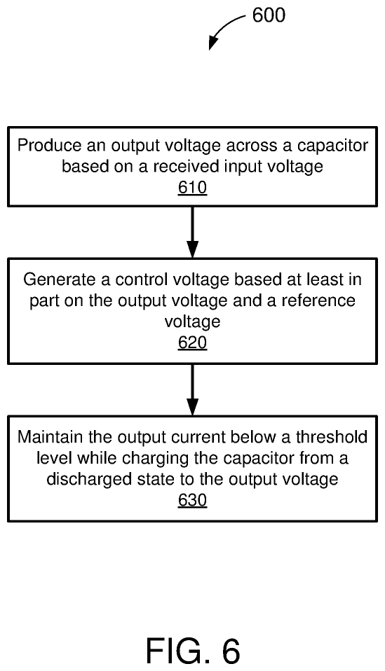

FIG. 6 is an illustrative flowchart depicting an example operation 600 for mitigating in-rush current in an LDO regulator, in accordance with some embodiments. With reference for example to FIG. 1, the example operation 600 may be performed by the LDO regulator 100.

The LDO regulator may produce an output voltage across a capacitor based on a received input voltage (610). With reference for example to FIG. 1, the pass element 110 may produce the output voltage Vₒᵤₜ across the capacitor Cₒᵤₜ based on the received voltage Vᵢₙ. In some aspects, the pass element 110 may have a variable resistance (or capacitance) that is adjustable via a control voltage V_{ctrl}. More specifically, the control voltage V_{ctrl} may control a voltage drop across the pass element 110. For example, in some implementations, the pass element 110 may comprise one or more metal-oxide semiconductor field-effect transistors (MOSFETs), such as PMOS transistors and/or NMOS transistors.

The LDO regulator may also generate a control voltage based at least in part on the output voltage and a reference voltage (620). With reference for example to FIG. 1, the error amplifier 120 may generate the control voltage V_{ctrl} based on the output voltage (e.g., in the form of the feedback voltage V_{FB}) and the reference voltage V_{ref}. Specifically, the error amplifier 120 compares the output voltage Vₒᵤₜ with the reference voltage V_{ref} and adjusts the control voltage V_{ctrl} based, at least in part, on a difference between the voltages Vₒᵤₜ and V_{ref}. During operation, variations in the input voltage Vᵢₙ and/or changes in resistance of the external load may cause changes in the output current Iₒᵤₜ. Such changes in the output current Iₒᵤₜ may, in turn, affect the output voltage Vₒᵤₜ. The error amplifier 120 adjusts the voltage drop across the pass element 110 (e.g., by changing a resistance of the pass element 110), in response to changes in the output current Iₒᵤₜ, to maintain the output voltage Vₒᵤₜ at a relatively constant voltage.

Further, the LDO regulator may maintain the output current below a threshold level while charging the capacitor from a discharged state to the output voltage (630). With reference for example to FIG. 1, the ICP circuitry 130 may control the flow of in-rush current when powering on the LDO regulator 100. More specifically, the ICP circuitry 130 may throttle the output current Iₒᵤₜ, during device power-up, by adjusting the resistance of the pass element 110. In some aspects, the ICP circuitry 130 may pre-charge the capacitor Cₒᵤₜ to a predetermined level to reduce the draw of output current Vₒᵤₜ by the capacitor Cₒᵤₜ. In some other aspects, the ICP circuitry 130 may maintain a resistance of the pass element 110 at a relatively high level to limit the flow of output current through the pass element 110. After the output current Iₒᵤₜ reaches a substantially steady-state level, the ICP circuitry 130 may be deactivated or bypassed, thus allowing the LDO regulator 100 to resume normal operation.

Although specific embodiments have been described with respect to LDO regulators, those of skill in the art will appreciate that the in-rush current protection techniques disclosed herein may be applicable to other types of linear voltage regulators. Further, those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

1. A linear voltage regulator, comprising:
a pass element configured to produce an output voltage across a capacitor based on a received input voltage;
an error amplifier configured to output a control voltage based at least in part on the output voltage and a reference voltage, wherein the control voltage is used to control a flow of output current through the pass element; and
in-rush current protection (ICP) circuitry coupled to the pass element and the error amplifier, wherein the ICP circuitry is configured to maintain the output current below a threshold level while charging the capacitor from a discharged state to the output voltage and wherein the ICP circuitry includes:
switching circuitry configured to selectively suppress the reference voltage at an input of the error amplifier; and
a transistor coupled in parallel with the pass element and configured to provide a pre-charge current to the capacitor when the reference voltage is suppressed, wherein a drain of the transistor is switchably coupled to the output of the error amplifier based at least in part on the charge on the capacitor.

2. The linear voltage regulator of claim 1, wherein the ICP circuitry is configured to charge the capacitor when powering on the linear voltage regulator.

3. The linear voltage regulator of claim 1, wherein the ICP circuitry is configured to charge the capacitor to a first threshold voltage while preventing the pass element from providing the output current to the capacitor.

4. (canceled)

5. The linear voltage regulator of claim 1, further comprising:
a low-pass filter coupled to the input of the error amplifier and configured to filter the reference voltage.

6. (canceled)

7. The linear voltage regulator of claim 3, wherein the drain is coupled to the output of the error amplifier when the capacitor is charged to the first threshold voltage, and wherein the transistor is configured to provide at least a portion of the output current when the drain is coupled to the output of the error amplifier.

8. The linear voltage regulator of claim 1, wherein the ICP circuitry includes a voltage clamp configured to throttle the output current through the pass element when the charge on the capacitor is below a second threshold voltage.

9. The linear voltage regulator of claim 8, wherein the voltage clamp comprises:
one or more transistors coupled between the output of the error amplifier and a first voltage potential, wherein the one or more transistors are configured to pull the control voltage toward the first voltage potential when the charge on the capacitor is below the second threshold voltage.

10. The linear voltage regulator of claim 9, wherein an impedance across the one or more transistors is lower than an output impedance of the error amplifier.

11. The linear voltage regulator of claim 9, wherein the first voltage potential corresponds to the input voltage.

12. The linear voltage regulator of claim 9, wherein at least one of the one or more transistors is turned off when the charge on the capacitor reaches the second threshold voltage.

13. A method of operating a linear voltage regulator, comprising:
producing an output voltage across a capacitor based on a received input voltage;
generating a control voltage based at least in part on the output voltage and a reference voltage, wherein the control voltage is used to control a flow of output current to the capacitor; and
maintaining the output current below a threshold level while charging the capacitor from a discharged state to the output voltage by:
switchably providing only one of the output current and a pre-charge current to the capacitor based at least in part on a comparison between a feedback voltage and a difference between the reference voltage and a threshold voltage; and
pre-charging the capacitor to a first threshold voltage while suppressing the flow of output current to the capacitor and providing the pre-charge current to the capacitor.

14. The method of claim 13, wherein the charging is performed when powering on the linear voltage regulator.

15. (canceled)

16. The method of claim 13, further comprising:
filtering the reference voltage via a low-pass filter.

17. The method of claim 13, wherein the charging further comprises:
throttling the flow of output current to the capacitor when the charge on the capacitor is below a second threshold voltage.

18. The method of claim 17, wherein the throttling comprises:
pulling the control voltage toward a first voltage potential when the charge on the capacitor is below the second threshold voltage.

19. The method of claim 18, further comprising:
releasing the pull on the control voltage when the charge on the capacitor reaches the second threshold voltage.

20. A linear voltage regulator, comprising:
a pass element configured to produce an output voltage across a capacitor based on a received input voltage;
an error amplifier configured to output a control voltage based at least in part on the output voltage and a reference voltage, wherein the control voltage is used to control a flow of output current through the pass element; and
in-rush current protection (ICP) circuitry coupled to the pass element and the error amplifier, the ICP circuitry being configured to:
switchably provide only one of the output current and a pre-charge current to the capacitor based at least in part on a comparison between a feedback voltage and a difference between the reference voltage and a threshold voltage;
pre-charge the capacitor to a first threshold voltage while preventing the pass element from providing the output current to the capacitor and providing the pre-charge current to the capacitor; and
throttle the output current through the pass element when the charge on the capacitor is below a second threshold voltage, wherein the second threshold voltage is between the first threshold voltage and the output voltage.
